(19) United States
(12) Patent Application Publication
(10) Pub. No.: US 2026/0062131 A1
(43) Pub. Date: Mar. 5, 2026

(54) REMOTELY OPERATED LATCH FOR AIRCRAFT

(71) Applicant: Rohr, Inc., Chula Vista, CA (US)

(72) Inventor: Theodore P. Barlam, Poway, CA (US)

(21) Appl. No.: 19/314,672

(22) Filed: Aug. 29, 2025

Related U.S. Application Data
(60) Provisional application No. 63/689,342, filed on Aug. 30, 2024.

(51) Int. Cl. B64D 29/06; B64F 5/10

(52) U.S. Cl. CPC B64D 29/06; B64F 5/10

(57) ABSTRACT

A latch assembly is provided for an aircraft. The latch assembly includes an engager assembly having an eye bolt assembly, a first drive rod, and a drive input disposed remote from the eye bolt assembly. The eye bolt assembly includes an eye bolt. The drive input is operatively coupled to the eye bolt assembly via the first drive rod for translation of the eye bolt at the eye bolt assembly. The latch assembly also includes a receiver assembly having a latch receiver and a control handle. The latch receiver is configured to receive the eye bolt. The control handle is operatively coupled to the latch receiver for at least one of engagement or disengagement with the eye bolt within the latch receiver.

This application claims priority to U.S. Patent Appln. No. 63/689,342 filed Aug. 30, 2024, which is hereby incorporated herein by reference in its entirety.

### TECHNICAL FIELD

This disclosure relates generally to an aircraft and, more particularly, to a latch for the aircraft.

### BACKGROUND OF THE ART

An aircraft propulsion system may include a thrust reverser to aid in aircraft landing. Various types and configurations of thrust reversers are known in the art. Various types and configurations of latches are also known in the art. While these known thrust reversers and latches have various benefits, there is still room in the art for improvement.

### SUMMARY

According to an aspect of the present disclosure, a latch assembly is provided for an aircraft. The latch assembly includes an engager assembly having an eye bolt assembly, a first drive rod, and a drive input disposed remote from the eye bolt assembly. The eye bolt assembly includes an eye bolt. The drive input is operatively coupled to the eye bolt assembly via the first drive rod for translation of the eye bolt at the eye bolt assembly. The latch assembly also includes a receiver assembly having a latch receiver and a control handle. The latch receiver is configured to receive the eye bolt. The control handle is operatively coupled to the latch receiver for at least one of engagement or disengagement with the eye bolt within the latch receiver.

In any of the aspects or embodiments described above and herein, the eye bolt assembly may be gear driven, and rotation of the drive input and the first drive rod may enable gear-driven translation of the eye bolt.

In any of the aspects or embodiments described above and herein, the drive input may be configured to accept a ratchet for rotation of the drive input and the first drive rod.

In any of the aspects or embodiments described above and herein, the engager assembly may further include a spring-loaded lock collar disposed proximate to the drive input, and a lock plate configured for engagement with the spring-loaded lock collar. Engagement of the spring-loaded lock collar and the lock plate may disable rotation of the drive input with the first drive rod. Disengagement of the spring-loaded lock collar and the lock plate may enable rotation of the drive input with the first drive rod.

In any of the aspects or embodiments described above and herein, the spring-loaded lock collar may include lock collar teeth, and the lock plate may include lock plate teeth configured for engagement with the lock collar teeth.

In any of the aspects or embodiments described above and herein, the eye bolt assembly may include a pinion gear engaged with the first drive rod within the eye bolt assembly, and a ring gear perpendicularly engaged with the pinon gear within the eye bolt assembly. The eye bolt may be translationally engaged through a center of the ring gear. Rotation of the first drive rod may enable rotation of the pinion gear, rotation of the ring gear, and translation of the eye bolt.

In any of the aspects or embodiments described above and herein, the eye bolt assembly may include a pin disposed on the eye bolt within the eye bolt assembly, and a slot disposed on the eye bolt assembly and configured to receive the pin and restrict translation of the eye bolt based on a disposition of the pin within the slot.

In any of the aspects or embodiments described above and herein, the receiver assembly may further include a second drive rod. The control handle may be disposed remote from the latch receiver. The control handle may be operatively coupled to the latch receiver via the second drive rod.

In any of the aspects or embodiments described above and herein, the eye bolt may include a guidance tip, an alignment body, and a bumper that enable proper alignment of the eye bolt within the latch receiver for engagement with the second drive rod.

In any of the aspects or embodiments described above and herein, the eye bolt may further include an eye bolt slot disposed through the alignment body. The second drive rod may extend through the eye bolt slot for engagement of the latch assembly. The second drive rod may retract from the eye bolt slot for disengagement of the latch assembly.

In any of the aspects or embodiments described above and herein, the control handle may be engaged with the second drive rod to enable translation of the second drive rod to extend through the eye bolt slot or retract from the eye bolt slot within the latch receiver.

In any of the aspects or embodiments described above and herein, at least one of the first drive rod or the second drive rod may include two angularly offset drive rod segments.

In any of the aspects or embodiments described above and herein, the eye bolt assembly may be engaged with a first fitting within a first inner structure section of a nacelle of the aircraft. The latch receiver may be engaged with a second fitting within a second inner structure section of the nacelle. The latch assembly may be configured to latch the first inner structure section with the second inner structure section.

In any of the aspects or embodiments described above and herein, the first drive rod and the drive input may be disposed within the first inner structure section. The second drive rod and the control handle may be disposed within the second inner structure section. The first inner structure section may include a first latch access door on a first radially exterior surface that provides access to the drive input. The second inner structure section may include a second latch access door on a second radially exterior surface that provides access to the control handle.

According to an aspect of the present disclosure, a latch assembly is provided for an aircraft. The latch assembly includes an engager assembly having an eye bolt assembly and a drive input. The eye bolt assembly includes an eye bolt. The drive input is operatively coupled to the eye bolt assembly for translation of the eye bolt at the eye bolt assembly. A receiver assembly includes a latch receiver, a drive rod, and a control handle disposed remote from the latch receiver. The latch receiver is configured to receive the eye bolt. The control handle is operatively coupled to the latch receiver via the drive rod for at least one of engagement or disengagement of the drive rod with the eye bolt within the latch receiver.

According to an aspect of the present disclosure, a method of operating a latch assembly of an aircraft is provided. A first inner structure section is partially closed with a second inner structure section of a nacelle of the aircraft. The first inner structure section includes an engager assembly of the latch assembly, and the second inner structure section includes a receiver assembly of the latch assembly. A drive input of the engager assembly is engaged to extend an eye bolt from an eye bolt assembly of the engager assembly. The eye bolt is extended into a latch receiver of the receiver assembly. A control handle of the receiver assembly is engaged to secure the eye bolt within the latch receiver. The drive input is engaged to retract the eye bolt into the eye bolt assembly for full closure of the first inner structure section with the second inner structure section.

In any of the aspects or embodiments described above and herein, engaging the drive input to extend the eye bolt may include releasing a rotation lock and rotating the drive input and a first drive rod in a first direction. The drive input may be engaged with the eye bolt assembly via the first drive rod.

In any of the aspects or embodiments described above and herein, the first drive rod may rotate a pinion gear of the eye bolt assembly, the pinion gear may be perpendicularly engaged with a ring gear of the eye bolt assembly, and rotation of the ring gear may translate the eye bolt through the ring gear and out from the eye bolt assembly.

In any of the aspects or embodiments described above and herein, engaging the drive input to retract the eye bolt may include releasing the rotation lock and rotating the drive input and the first drive rod in a second direction, enabling rotation of the pinion gear and the ring gear, and translation of the eye bolt through the ring gear into the eye bolt assembly.

In any of the aspects or embodiments described above and herein, engaging the control handle may include translating a second drive rod through an eye bolt slot of the eye bolt within the latch receiver.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### DESCRIPTION OF THE DRAWINGS

FIG. 1 is a schematic illustration of an aircraft propulsion system with a thrust reverser in a stowed position, in accordance with one or more embodiments of the present disclosure.

FIG. 2 is a schematic illustration of the aircraft propulsion system with the thrust reverser in a deployed position, in accordance with one or more embodiments of the present disclosure.

FIG. 3 is a schematic end view illustration of the aircraft propulsion system with the thrust reverser in the stowed position, in accordance with one or more embodiments of the present disclosure.

FIG. 4 is a partial schematic sectional illustration of the aircraft propulsion system, in accordance with one or more embodiments of the present disclosure.

FIG. 5 is a schematic end view illustration of the aircraft propulsion system with pivotable structures in open positions, in accordance with one or more embodiments of the present disclosure.

FIG. 6 is a partial schematic illustration of the aircraft propulsion system along a thrust reverser system in a stowed arrangement, in accordance with one or more embodiments of the present disclosure.

FIG. 7 is a partial schematic illustration of the aircraft propulsion system along the thrust reverser system in a deployed arrangement, in accordance with one or more embodiments of the present disclosure.

FIG. 8 is a schematic end view illustration of the aircraft propulsion system with the thrust reverser in the deployed position, in accordance with one or more embodiments of the present disclosure.

FIG. 9 schematically illustrates a partially cutaway split perspective view of inner structure sections and outer structure sections of the aft structure, in accordance with one or more embodiments of the present disclosure.

FIG. 10A schematically illustrates a perspective view of a remotely operated latch assembly of the inner structure sections with an eye bolt assembly in an extended state, in accordance with one or more embodiments of the present disclosure.

FIG. 10B schematically illustrates a perspective view of the remotely operated latch assembly with the eye bolt assembly in a retracted state, in accordance with one or more embodiments of the present disclosure.

FIG. 11A schematically illustrates a perspective view of a drive input for the eye bolt assembly, in accordance with one or more embodiments of the present disclosure.

FIG. 11B schematically illustrates cutaway perspective view of the drive input for the eye bolt assembly, in accordance with one or more embodiments of the present disclosure.

FIG. 12 schematically illustrates a perspective view of the eye bolt assembly in the extended state, in accordance with one or more embodiments of the present disclosure.

FIG. 13 schematically illustrates a radially outward view of the eye bolt assembly in the retracted state, in accordance with one or more embodiments of the present disclosure.

FIG. 14 schematically illustrates a perspective view of the eye bolt assembly engaged with a latch receiver in the extended state, in accordance with one or more embodiments of the present disclosure.

FIG. 15A schematically illustrates a radially outward view of the eye bolt assembly engaged with the latch receiver in the extended state, in accordance with one or more embodiments of the present disclosure.

FIG. 15B schematically illustrates a cutaway radially outward view of the eye bolt assembly engaged with the latch receiver in the extended state, in accordance with one or more embodiments of the present disclosure.

FIG. 16A schematically illustrates an axially forward view of the eye bolt assembly engaged with the latch receiver in the extended state, in accordance with one or more embodiments of the present disclosure.

FIG. 16B schematically illustrates a cutaway axially forward view of the eye bolt assembly engaged with the latch receiver in the extended state, in accordance with one or more embodiments of the present disclosure.

FIG. 17 schematically illustrates a perspective view of the eye bolt assembly engaged with the latch receiver in the retracted state, in accordance with one or more embodiments of the present disclosure.

FIG. 18A schematically illustrates a radially outward view of the eye bolt assembly engaged with the latch receiver in the retracted state, in accordance with one or more embodiments of the present disclosure.

FIG. 18B schematically illustrates a cutaway radially outward view of the eye bolt assembly engaged with the latch receiver in the retracted state, in accordance with one or more embodiments of the present disclosure.

FIG. 19A schematically illustrates an axially forward view of the eye bolt assembly engaged with the latch receiver in the retracted state, in accordance with one or more embodiments of the present disclosure.

FIG. 19B schematically illustrates a cutaway axially forward view of the eye bolt assembly engaged with the latch receiver in the retracted state, in accordance with one or more embodiments of the present disclosure.

FIG. 20 schematically illustrates a cutaway axially forward view of the eye bolt assembly disengaged from the latch receiver in the extended state, in accordance with one or more embodiments of the present disclosure.

FIG. 21 is a flowchart illustrating a method for operating the latch assembly of the aircraft, in accordance with one or more embodiments of the present disclosure.

### DETAILED DESCRIPTION

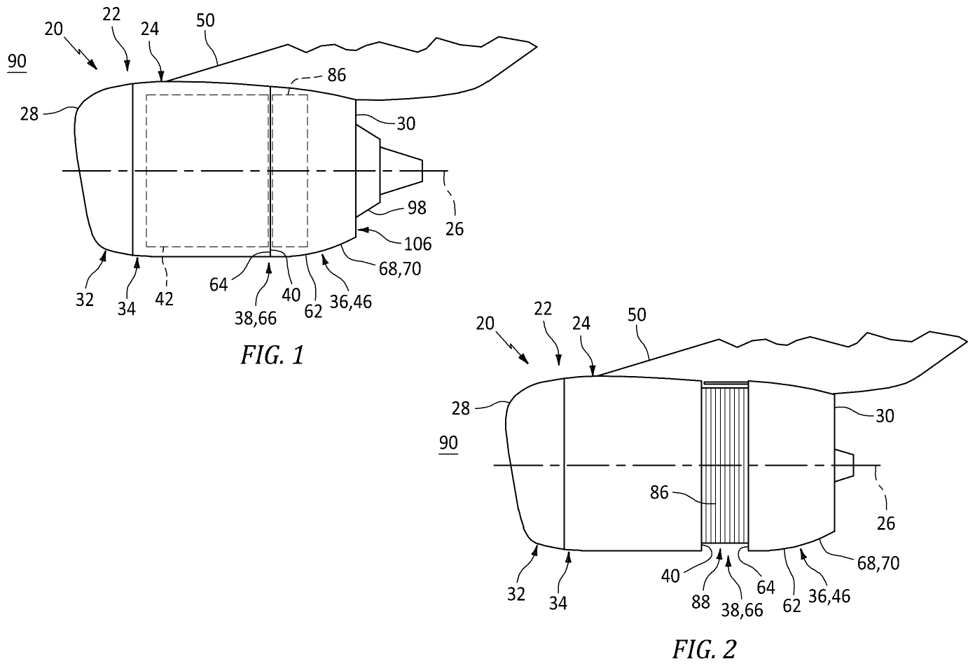

FIG. 1 illustrates an aircraft propulsion system 20 for an aircraft. The aircraft may be an airplane, a drone (e.g., an unmanned aerial vehicle (UAV)) or any other manned or unmanned aerial vehicle or system. The aircraft propulsion system 20 includes a gas turbine engine and a nacelle 22.

The gas turbine engine is configured to power operation of the aircraft propulsion system 20. The gas turbine engine is also configured to produce thrust to propel the aircraft during flight. For ease of description, the gas turbine engine is generally described below as a turbofan engine such as a high-bypass turbofan engine. The present disclosure, however, is not limited to such an exemplary gas turbine engine. Moreover, while the aircraft propulsion system 20 is described as including the gas turbine engine to power operation and produce thrust, it is contemplated the gas turbine engine may be replaced by (or augmented with) one or more propulsor rotors (e.g., fan rotors and/or other air movers) driven by a hybrid-electric power unit or a fully electric power unit.

The nacelle 22 is configured to house and provide an aerodynamic cover for the gas turbine engine. An outer structure 24 of the nacelle 22 (e.g., an outer fixed structure (OFS)) extends along a centerline axis 26 from a forward end 28 of the nacelle 22 and its outer structure 24 to an aft end 30 of the nacelle outer structure 24. The nacelle outer structure 24 of FIG. 1 includes an inlet structure 32, one or more fan cowls 34 (one such fan cowl visible in FIG. 1) and an aft structure 36, which aft structure 36 is configured as part of or otherwise includes a thrust reverser 38 (see also FIG. 2).

The inlet structure 32 is disposed at the nacelle forward end 28. The inlet structure 32 is configured to direct a stream of air through an inlet opening at the nacelle forward end 28 and into a fan section of the gas turbine engine.

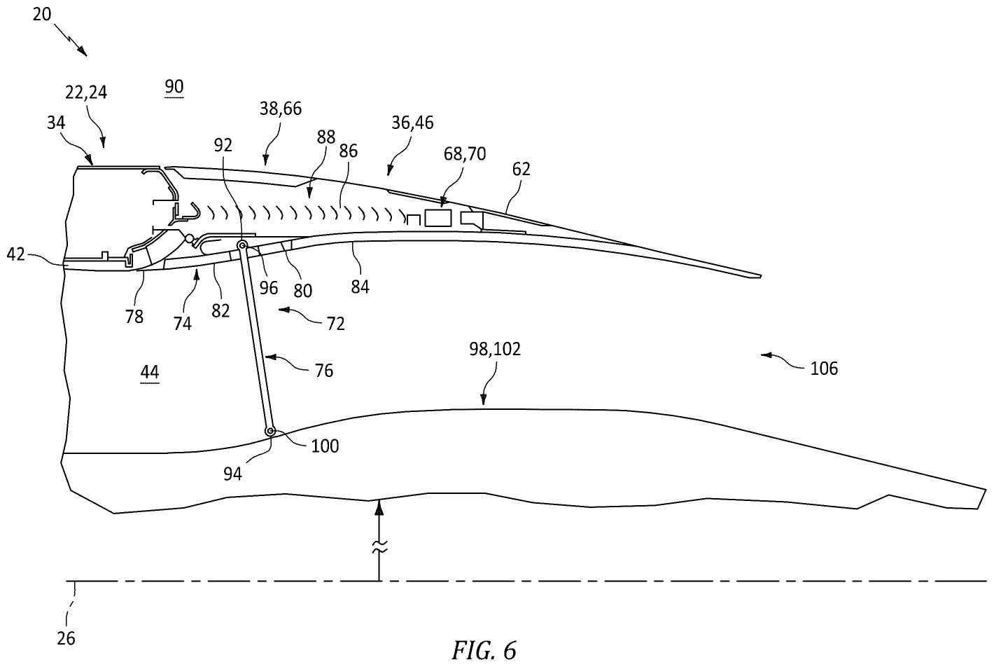

The fan cowls 34 are disposed axially between the inlet structure 32 and the aft structure 36. Each fan cowl 34 of FIG. 1, for example, is disposed at (e.g., on, adjacent or proximate) an aft end 40 of a stationary portion of the nacelle 22, and extends axially forward to the inlet structure 32. Each fan cowl 34 is generally axially aligned with the fan section of the gas turbine engine. The fan cowls 34 are configured to provide an aerodynamic covering over a fan case 42 for the fan section. Briefly, this fan case 42 circumscribes a fan rotor in the fan section and may partially form a forward outer peripheral boundary of a bypass flowpath 44 (see FIG. 6) of the aircraft propulsion system 20.

The term “stationary portion” is used above to describe a portion of the nacelle 22 that is stationary during aircraft propulsion system operation (e.g., during takeoff, aircraft flight and landing). However, the stationary portion may be otherwise movable for aircraft propulsion system inspection/maintenance; e.g., when the aircraft propulsion system 20 is non-operational. Each of the fan cowls 34, for example, may be configured to provide access to components of the gas turbine engine such as the fan case 42 and/or peripheral equipment configured therewith for inspection, maintenance and/or otherwise. In particular, each fan cowl 34 may be pivotally mounted with the aircraft propulsion system 20 by, for example, a pivoting hinge system. Alternatively, the fan cowls 34 and the inlet structure 32 may be configured into a single axially translatable body for example. The present disclosure, of course, is not limited to the foregoing fan cowl configurations and/or access schemes.

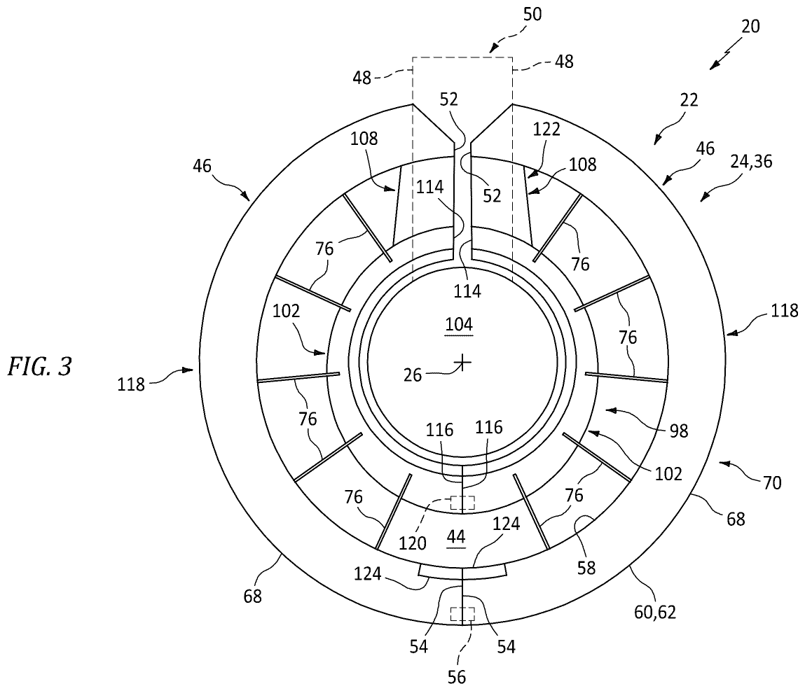

Referring to FIG. 3, the aft structure 36 includes a set of outer structure sections 46. These outer structure sections 46 are arranged on opposing sides of the aircraft propulsion system 20. More particularly, the outer structure sections 46 are arranged to opposing sides 48 of a stationary structure 50 such as a pylon structure for mounting the aircraft propulsion system 20 to an airframe of the aircraft.

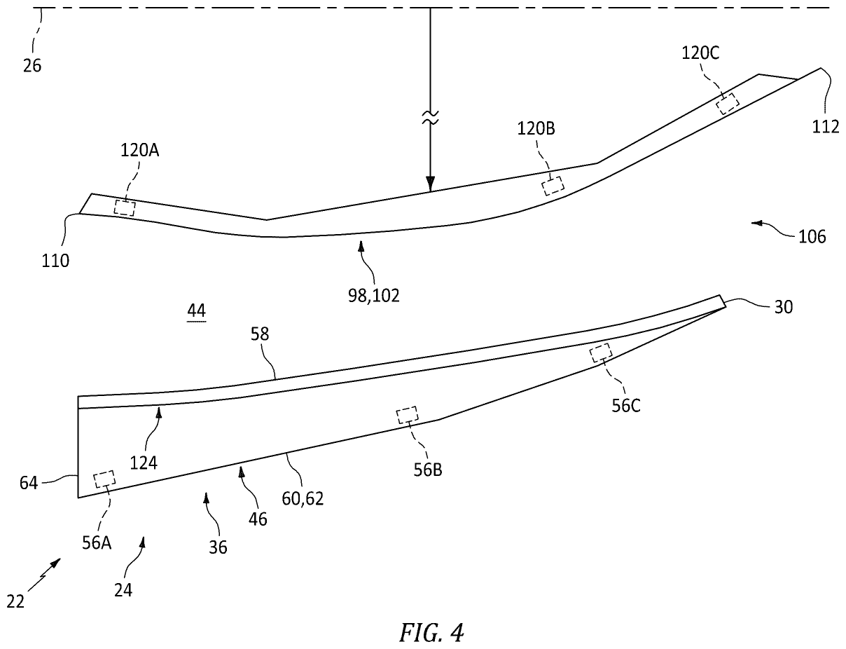

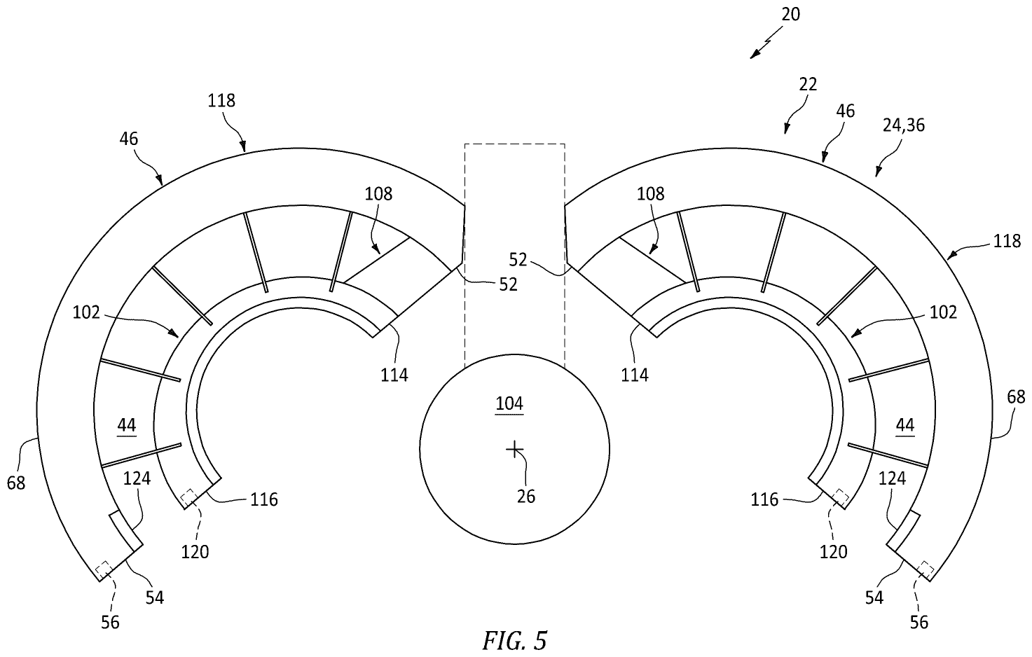

Each of the outer structure sections 46 extends circumferentially about the axis 26 from a circumferential first end 52 (e.g., a top end) of the respective outer structure section 46 to a circumferential second end 54 (e.g., a bottom end) of the respective outer structure section 46. At the outer structure section first end 52, each outer structure section 46 may be pivotally and/or otherwise moveably coupled to the stationary structure 50. At the outer structure section second ends 54, the outer structure sections 46 are removably attached to one another by one or more outer structure latches 56A-C (generally referred to as “56”). Referring to FIG. 4, these outer structure latches 56 may be arranged at discrete locations axially along the aft structure 36 and its outer structure sections 46. Referring again to FIG. 3, with such an arrangement, the outer structure sections 46 may collectively form a substantially annular body when the outer structure sections 46 are disposed in closed positions and attached together by the outer structure latches 56. Here, the annular outer structure body may extend circumferentially about the axis 26 at least, for example, three-hundred and thirty degrees (330°) or three-hundred and forty degrees (340°) between and to the opposing sides 48 of the stationary structure 50. However, when the outer structure latches 56 are unlatched to decouple the outer structure sections 46, each of the outer structure sections 46 may (e.g., independently) pivot and/or otherwise move from its closed position to an open position as shown, for example, in FIG. 5.

Each of the outer structure sections 46 of FIG. 3 extends radially from a radial inner side 58 of the respective outer structure section 46 to a radial outer side 60 of the respective outer structure section 46. Each outer structure section inner side 58 of FIG. 3 forms a radial outer peripheral boundary of a respective portion (e.g., downstream half) of the bypass flowpath 44. Each outer structure section outer side 60 of FIG. 3 forms an aerodynamic exterior surface 62 of the aircraft propulsion system 20 which is exposed to the ambient air outside of the aircraft propulsion system 20.

Referring to FIG. 1, each of the outer structure sections 46 extends axially along the axis 26 from a forward, upstream end 64 of the respective outer structure section 46 to the outer structure aft end 30. Similarly, each exterior surface 62 extends axially along the axis 26 from a forward, upstream end of the exterior surface 62 to the outer structure aft end 30. Here, the exterior surface upstream end may be the same as the outer structure section upstream end 64.

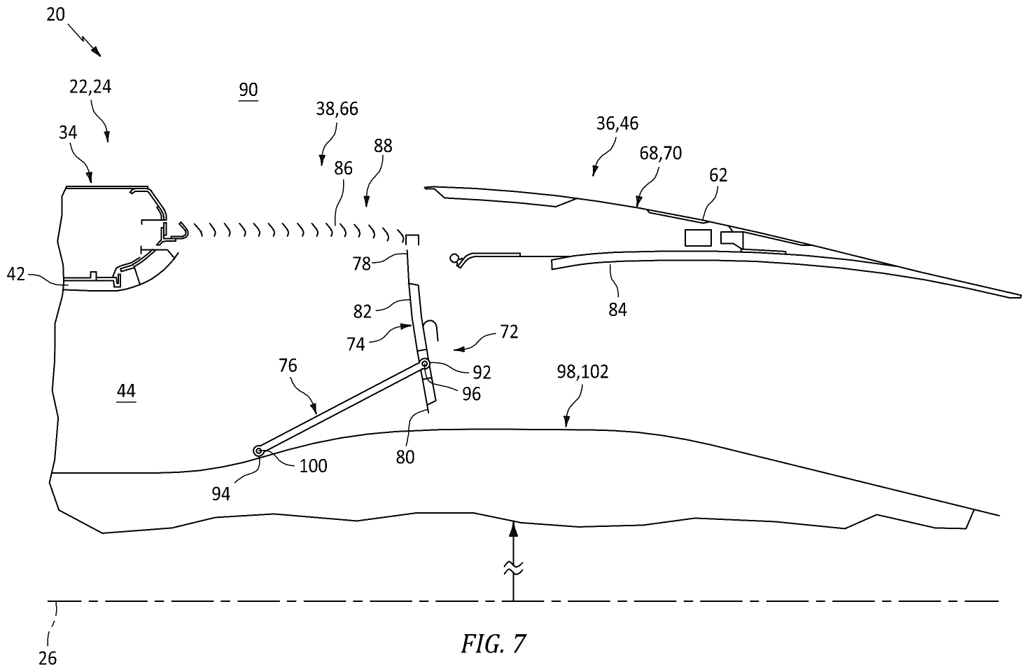

Referring to FIGS. 6 and 7, each outer structure section 46 is configured with a thrust reverser system 66. This thrust reverser system 66 includes a circumferential section 68 of a translating sleeve 70. Briefly, this sleeve section 68 includes/forms the respective exterior surface 62 and is configured to translate axially along the axis 26 between and to a stowed position (see FIG. 6) and a deployed position (see FIG. 7). The thrust reverser system 66 also includes one or more blocker door assemblies 72. Referring to FIG. 8, the blocker door assemblies 72 are arranged circumferentially about the axis 26 in an arcuate array circumferentially between the outer structure section first end 52 and the outer structure section second end 54.

Referring to FIGS. 6 and 7, the thrust reverser system 66 may be configured as an exposed drag link type thrust reverser system. Each blocker door assembly 72 of FIGS. 6 and 7, for example, includes a blocker door 74 and at least (or only) one door actuation linkage 76. Briefly, the door actuation linkage 76 is configured to actuate pivoting and/or other movement of the blocker door 74 between and to a stowed position (see FIG. 6) and a deployed position (see FIG. 7).

The blocker door 74 extends longitudinally between and to a first end 78 of the blocker door 74 and a second end 80 of the blocker door 74. This blocker door 74 is pivotally coupled to the sleeve section 68 (or another translating component) at or near the door first end 78. With this arrangement, the blocker door 74 is configured to pivot and/or otherwise move between its stowed position of FIG. 6 and its deployed position of FIG. 7.

When the blocker door 74 is in its stowed position of FIG. 6, the door first end 78 is a forward, upstream end of the blocker door 74 and the door second end 80 is an aft, downstream end of the blocker door 74. Here, the blocker door 74 is disposed outside of (e.g., next to and radially outboard of) the bypass flowpath 44. A side surface 82 of the blocker door 74 of FIG. 6, for example, forms a radial outer peripheral boundary of a respective portion of the bypass flowpath 44. This door side surface 82 may also be arranged flush with a radial inner surface 84 of the sleeve section 68.

When the blocker door 74 is in its deployed position of FIG. 7, the door first end 78 is a radial outer end of the blocker door 74 and the door second end 80 is a radial inner end of the blocker door 74. Here, the blocker door 74 is disposed in the bypass flowpath 44. The blocker door 74 of FIG. 7, for example, projects radially inward (e.g., towards the axis 26) into and substantially across the bypass flowpath 44. With this arrangement, the blocker door 74 and its side surface 82 are configured to block off a downstream portion of the bypass flowpath 44 and redirect air flowing in an upstream portion of the bypass flowpath 44 radially outward to flow through the outer structure section 46. Briefly, the downstream portion of the bypass flowpath 44 is a portion of the bypass flowpath 44 downstream of the deployed blocker door 74, and the upstream portion of the bypass flowpath 44 is a portion of the bypass flowpath 44 upstream of the deployed blocker door 74. The air redirected by the blocker door 74 flows radially outward (e.g., away from the axis 26) through a cascade structure 86 and a thrust reverser passage 88 into an environment 90 external to the aircraft propulsion system 20. The cascade structure 86 may further redirect the air flowing therethrough such that the air directed into the external environment 90 by the thrust reverser system 66 follows a trajectory with an axial forward component to provide reverse thrust.

The door actuation linkage 76 of FIGS. 6 and 7 is configured as a single drag link. The door actuation linkage 76 of FIGS. 6 and 7, for example, extends longitudinally from a first end 92 of the door actuation linkage 76 to a second end 94 of the door actuation linkage 76. The door actuation linkage 76 is pivotally and/or otherwise movably coupled to the blocker door 74 at the linkage first end 92, at an intermediate location between the door first end 78 and the door second end 80. Here, an outer pivot point 96 at the coupling between the door actuation linkage 76 and the blocker door 74 is a moveable pivot point in that the location of the outer pivot point 96 moves as the blocker door 74 moves between its stowed position of FIG. 6 and its deployed position of FIG. 7. The door actuation linkage 76 is pivotally and/or otherwise movably coupled to an inner structure 98 of the nacelle 22 (e.g., an inner fixed structure (IFS)) at the linkage second end 94. Here, an inner pivot point 100 at the coupling between the door actuation linkage 76 and the nacelle inner structure 98 is a stationary pivot point in that the location of the inner pivot point 100 does not move as the blocker door 74 moves between its stowed position of FIG. 6 and its deployed position of FIG. 7. With this arrangement, the door actuation linkage 76 extends radially across the bypass flowpath 44 when the blocker door 74 is in its stowed position. The door actuation linkage 76 further links the outer structure section 46 to a respective circumferential section 102 (e.g., an inner barrel section) of the nacelle inner structure 98.

During operation of the thrust reverser system 66, the door actuation linkage 76 operatively links the translating movement of the sleeve section 68 (or the other translating component) to the pivoting movement of the first blocker door 74. For example, as the sleeve section 68 translates axially aft from its stowed position of FIG. 6 to its deployed position of FIG. 7, the sleeve section 68 pulls the outer pivot point 96 axially aft. However, since the inner pivot point 100 is stationary, the door actuation linkage 76 pulls the blocker door 74 and its door second end 80 radially inward into the bypass flowpath 44. This motion may then be reversed when the sleeve section 68 translates axially forward from its deployed position of FIG. 7 to its stowed position of FIG. 6.

Referring to FIG. 3, the nacelle inner structure 98 and its members are configured to house a core 104 (e.g., a gas generator) of the gas turbine engine. The nacelle inner structure 98 and its members are configured to form at least a portion (or an entirety) of a radial inner peripheral boundary of the bypass flowpath 44. Referring to FIG. 1, the nacelle inner structure 98 also forms a bypass exhaust 106 from the bypass flowpath 44 with the aft structure 36 and its outer structure sections 46. Referring again to FIG. 3, the nacelle inner structure 98 includes the inner structure sections 102 and a plurality of (e.g., upper) bifurcation sections 108.

Referring to FIG. 4, each of the inner structure sections 102 extends axially along the axis 26 between opposing axial ends 110 and 112 of the respective inner structure section 102. Referring to FIG. 3, each inner structure section 102 extends circumferentially about the axis 26 from a circumferential first end 114 (e.g., a top end) of the respective inner structure section 102 to a circumferential second end 116 (e.g., a bottom end) of the respective inner structure section 102.

Each bifurcation section 108 is connected to (e.g., formed integral with or otherwise attached to) the respective inner structure section 102 at the inner structure section first end 114. Each bifurcation section 108 is connected to (e.g., formed integral with or otherwise attached to) the respective outer structure section 46 at the outer structure section first end 52. Each bifurcation section 108 of FIG. 3, for example, projects radially out from and structurally ties the respective inner structure section 102 to the respective outer structure section 46. With this arrangement, each respective set of the outer structure section 46, the inner structure section 102 and the bifurcation section 108 may collectively form a single pivotable structure 118; e.g., a thrust reverser half. More particularly, a respective set of the inner structure section 102 and the bifurcation section 108 is pivotally coupled to the stationary structure 50 through the respective outer structure section 46 and its coupling to the stationary structure 50. Each respective set of the outer structure section 46, the inner structure section 102 and the bifurcation section 108 is thereby operable to collectively move from its closed position of FIG. 3 to its open position of FIG. 5 as the single pivotable structure 118.

At the inner structure section second ends 116, the inner structure sections 102 are (e.g., removably) attached to one another by one or more inner structure latches 120A-C (generally referred to as “120”). Referring to FIG. 4, these inner structure latches 120 may be arranged at discrete locations axially along the nacelle inner structure 98 and its inner structure sections 102. Referring again to FIG. 3, with this arrangement, the inner structure sections 102 may collectively form a substantially annular body when the inner structure sections 102 are disposed in their closed positions and attached together by the inner structure latches 120. Here, the annular inner structure body may extend circumferentially about the axis 26 at least, for example, three-hundred and thirty degrees (330°) or three-hundred and forty degrees (340°) between and to opposing sides of a bifurcation 122/the bifurcation sections 108. However, when the inner structure latches 120 are unlatched to decouple the inner structure sections 102, each of the inner structure sections 102 may pivot and/or otherwise move with the respective pivotable structure 118 from the closed position of FIG. 3 to the open position of FIG. 5.

In some embodiments, referring to FIG. 4, the forward, upstream inner structure latch 120A may be disposed at or near the forward, upstream end 110 of the inner structure section 102. The aft, downstream inner structure latch 120C may be disposed at or near the aft, downstream end 112 of the inner structure section 102. The intermediate inner structure latch 120B is disposed at an intermediate position axially along the axis 26 between the upstream inner structure latch 120A and the downstream inner structure latch 120C. This intermediate inner structure latch 120B may be located axially along the axis 26 closer in proximity to the downstream inner structure latch 120C than to the upstream inner structure latch 120A.

In some embodiments, the aft structure 36 and its outer structure sections 46 may axially and circumferentially overlap one or more of the inner structure latches 120; e.g., 120A and 120B. However, it is contemplated the aft structure 36 and its outer structure sections 46 may not axially and circumferentially overlap at least one of the inner structure latches 120; e.g., 120C. The downstream inner structure latch 120C of FIG. 4, for example, is located axially of the outer structure aft end 30.

In some embodiments, each of the outer structure sections 46 may be configured with a sound attenuation structure 124. This sound attenuation structure 124 faces the nacelle inner structure 98 and extends longitudinally along the bypass flowpath 44. The sound attenuation structure 124 of FIG. 4, for example, extends axially along the respective outer structure section 46 from (or about) the forward, upstream end 64 of the respective outer structure section 46 to (or about) the aft, downstream end of the respective outer structure section 46; e.g., the outer structure aft end 30. With this arrangement, referring to FIGS. 3 and 4, the sound attenuation structure 124 may axially and circumferentially overlap one or more of the inner structure latches 120; e.g., 120A and 120B. Referring to FIG. 3, the sound attenuation structure 124 of one outer structure section 46 may be circumferentially next to and/or abut against the sound attenuation structure 124 of the other outer structure section 46. Here, the sound attenuation structures 124 are arranged diametrically opposite the bifurcation 122 and its bifurcation sections 108 as well as the stationary structure 50. Briefly, the sound attenuation structures 124 may be configured as or otherwise include one or more acoustic panels. Each acoustic panel may include a cellular core (e.g., a honeycomb core) sandwiched between a perforated face sheet and a non-perforated back sheet. Of course, various other types of sound attenuation structures are known in the art, and the present disclosure is not limited to any particular types thereof.

Referring to FIG. 3, the bypass flowpath 44 is formed by and extends radially uninterrupted between (a) the aft structure 36 and its members 46 and (b) the nacelle inner structure 98 and its members 102. The bypass flowpath 44 is also formed by and extends circumferentially uninterrupted about the axis 26 at least, for example, three-hundred and thirty degrees (330°) or three-hundred and forty degrees (340°) between the opposing sides of the bifurcation 122/the bifurcation sections 108.

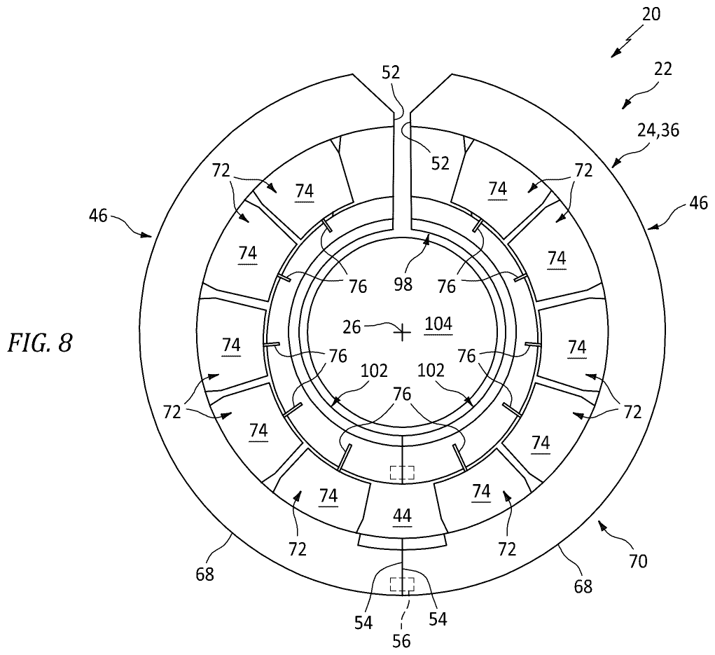

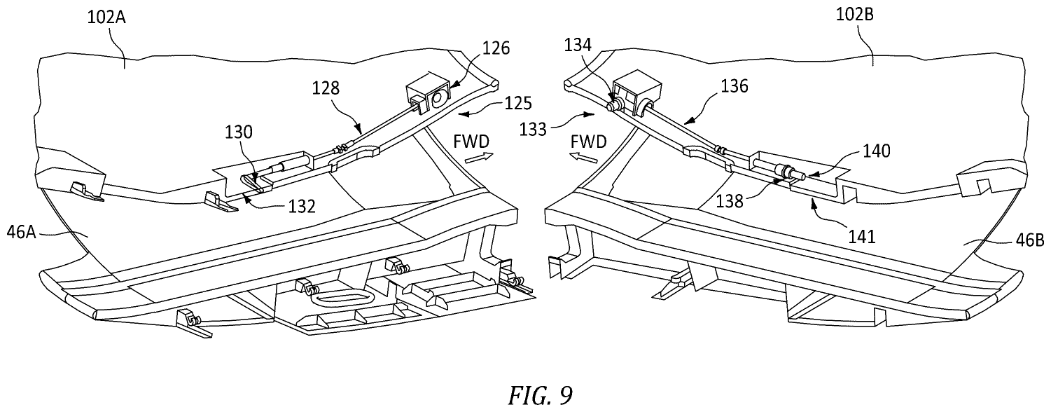

Example configurations of the forward, upstream inner structure latch 120A are shown in FIGS. 9-20. Here, the forward, upstream inner structure latch 120A is configured as a remotely actuated latch. For example, a control handle 130 for the forward, upstream inner structure latch 120A may be axially spaced from a latch receiver for the forward, upstream inner structure latch 120A. With this arrangement, personnel may more readily reach the control handle when a location of the latch receiver may be otherwise inaccessible. Of course, it is contemplated such a remotely actuated latch may be used for other latches of the aircraft propulsion system 20 and/or, more generally, for other latches of the aircraft.

FIG. 9 schematically illustrates a partially cutaway split perspective view of inner structure sections and outer structure sections of the aft structure 36. A first inner structure section 102A is disposed within a first outer structure section 46A, and a second inner structure section 102B is disposed within a second outer structure section 46B. The first inner structure section 102A includes a receiver assembly 125 of a latch assembly for the upstream inner structure latch 120A. The receiver assembly 125 of the latch assembly includes a latch receiver 126, a drive rod 128, the control handle 130, and a first latch access door 132. The first latch access door 132 enables access to the control handle 130 within the first inner structure section 102A. The control handle 130 may be spring-loaded. Engagement of the control handle 130 translates the drive rod 128 in an axial direction within the latch receiver 126.

The second inner structure section 102B includes an engager assembly 133 of the latch assembly for the upstream inner structure latch 120A. The engager assembly 133 of the latch assembly includes a gear-driven eye bolt assembly 134, a rotating drive rod 136, a rotation lock 138, a square drive input 140, and a second latch access door 141. The second latch access door 141 enables access to the square drive input 140 within the second inner structure section 102B. The square drive input 140 may accept a ratchet, and rotation of the square drive input 140 with the ratchet rotates the rotating drive rod 136. Rotation of the rotating drive rod 136 translates an eye bolt of the gear-driven eye bolt assembly 134 from between a retracted state and an extended state in a generally radial direction. The eye bolt of the gear-driven eye bolt assembly may mate with the drive rod 128 within the latch receiver 126. The gear-driven eye bolt assembly 134 also functions as an alignment pin and a bumper.

The present disclosure is not limited to any particular size or shape of the components of the receiver assembly 125 and the engager assembly 133. The present disclosure is not limited to the placement of the receiver assembly 125 and the engager assembly 133. For example, the receiver assembly 125 may be disposed within the second inner structure section 102B and the engager assembly 133 may be disposed within the first inner structure section 102A.

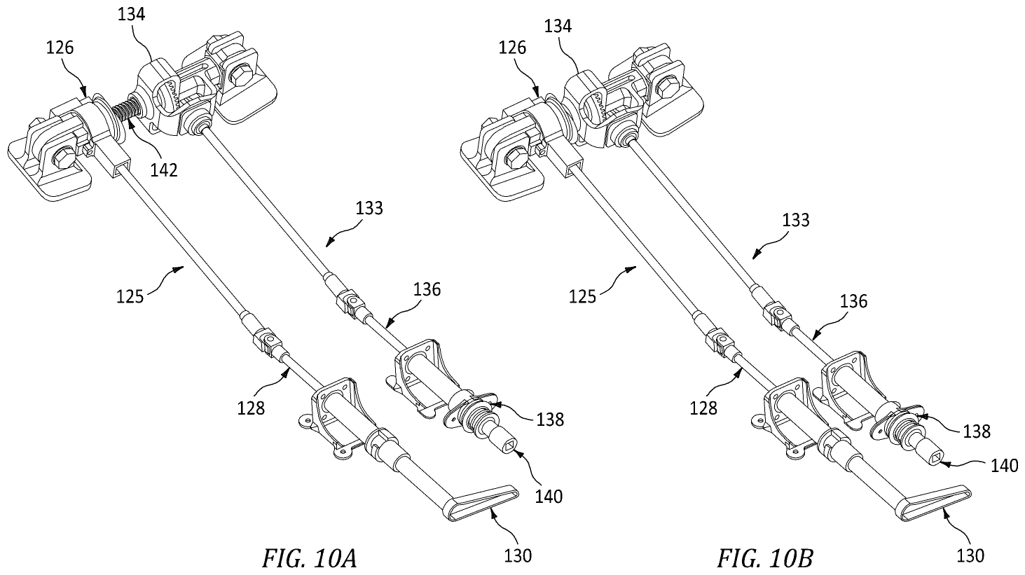

FIG. 10A schematically illustrates a perspective view of a remotely operated latch assembly of the first and second inner structure sections 102A, 102B with the gear-driven eye bolt assembly 134 in an extended state. With respect to the engager assembly 133, an eye bolt 142 of the gear-driven eye bolt assembly 134 extends a predefined distance in the extended state. The extension of the gear-driven eye bolt assembly 134 is based on rotation of the square drive input 140 and the rotating drive rod 136 in a first direction. An end of the eye bolt 142 is disposed within the latch receiver 126 of the receiver assembly 125. The control handle 130 is disposed in a position that secures the eye bolt 142 within the latch receiver 126. For example, the position of the control handle 130 translates the drive rod 128 axially forward in the latch receiver 126 into a slot of the eye bolt 142. The extended state of the gear-driven eye bolt assembly 134 with the latch system engaged may be utilized in a maintenance state, in which an operator may pull thrust reverser halves such that they are resting on seals and not fully closed. The present disclosure is not limited to any particular extension distance of the eye bolt 142. At least one of the drive rod 128 or the rotation drive rod 136 may be embodied as two angularly offset drive rod segments.

FIG. 10B schematically illustrates a perspective view of the remotely operated latch assembly of the first and second inner structure sections 102A, 102B with the gear-driven eye bolt assembly 134 in a retracted state. The eye bolt 142 is retracted within the gear-driven eye bolt assembly 134 based on rotation of the square drive input 140 and the rotating drive rod 136 in a second direction, which is opposite the first rotational direction. The end of the eye bolt 142 remains secured within the latch receiver 126 and engaged with the drive rod 128. The retracted state of the gear-driven eye bolt assembly 134 with the latch system engaged may be utilized in a flight condition, in that thrust reverser halves are fully closed.

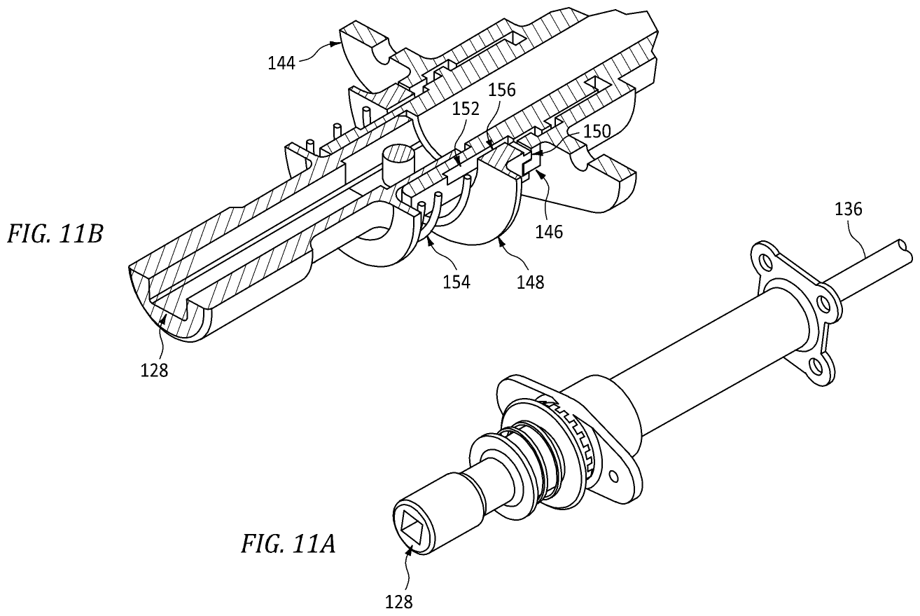

FIG. 11A schematically illustrates a perspective view of the rotation lock 138 and the square drive input 140 for the latch assembly. FIG. 11B schematically illustrates a cutaway perspective view of the rotation lock 138 and the square drive input 140 for the latch assembly. The square drive input 140 accepts a rachet handle to rotate the rotating drive rod 136. The rotation lock 138 includes a lock plate 144 having lock plate teeth 146, as well as a lock collar 148 with lock collar teeth 150. The rotation lock 138 also includes a guide slot 152 and a spring 154. The lock collar 148 includes a guide key 156 that engages the guide slot 152 and enables the lock collar 148 to translate axially in the rotation lock 138. Specifically, the axial translation of the lock collar 148 results in engagement and disengagement of the lock plate teeth 146 and the lock collar teeth 150. The lock collar 148 is also spring-loaded by the spring 154. A locked state of the rotation lock 138 may be established by releasing the spring-loaded lock collar 148 and engaging the lock plate teeth 146 and the lock collar teeth 150. Attempted rotation of the square drive input 140 in the locked state will not result in rotation of the rotating drive rod 136. An unlocked state of the rotation lock 138 may be established by pulling back the spring-loaded lock collar 148 and disengaging the lock plate teeth 146 and the lock collar teeth 150. Rotation of the square drive input 140 in the unlocked state results in rotation of the rotating drive rod 136. The present disclosure is not limited to any particular manner of locking the lock plate 144 and the lock collar 148. The present disclosure is also not limited to the square drive input 140, and any drive input may be employed that receives a tool for rotation of the drive input and the rotating drive rod 136.

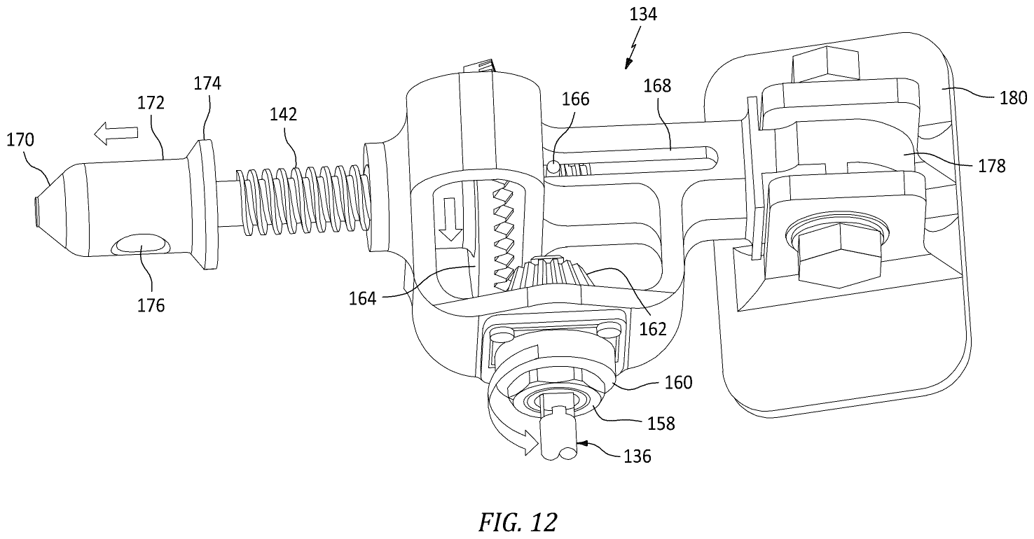

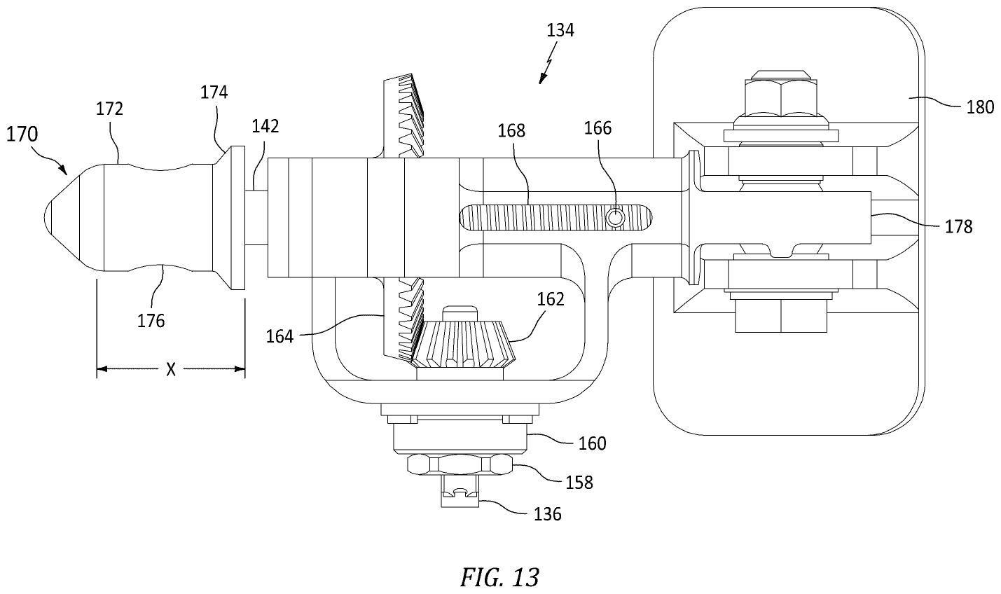

FIG. 12 schematically illustrates a perspective view of the gear-driven eye bolt assembly 134 in the extended state. FIG. 13 schematically illustrates a radially outward view of the eye bolt assembly in the retracted state. A square drive end of the drive rod 136 may be engaged with the gear-driven eye bolt assembly 134 via a square drive socket in a pinion gear 162 that is retained by a nut 158 and supported by a double bearing pack 160. Rotation of the drive rod 136 by the square drive input 140 enables rotation of the pinion gear 162 within the gear-driven eye bolt assembly 134. A first set of teeth of the pinion gear 162 are perpendicularly engaged with a second set of teeth of a ring gear 164. Rotation of the pinion gear 162 enables rotation of the ring gear 164, which engages the eye bolt 142 and enables translation (extension and retraction) of the eye bolt 142 through a central bore of the ring gear 164. For example, threads within the central bore of the ring gear 164 engage with threads on the eye bolt 142 for conversion of the rotation motion of the ring gear 164 into linear or translational motion of the eye bolt 142. A pin 166 is disposed on the eye bolt 142, and is received within a slot 168 of the gear-driven bolt assembly 134. The pin 166 acts as a travel guide and travel stop for extension and retraction of the eye bolt 142. The present disclosure is not limited to any particular size or placement of the pin 166 on the eye bolt 142 or any particular disposition of the slot 168 on the eye bolt assembly 134.

The eye bolt 142 includes a guidance tip 170, an alignment body 172, and a bumper 174. An eye bolt slot 176 extends through the alignment body 172. The guidance tip 170, the alignment body 172, and the bumper 174 enable proper engagement, alignment, and placement of the eye bolt slot 176 within the latch receiver 126 such that the drive rod 128 may translate axially into the eye bolt slot 176 within the latch receiver 126. A spherical bearing 178 of the gear-driven eye bolt assembly 134 may engage with a fitting 180 (e.g., a clevis fitting) disposed within the second inner structure section 102B. The eye bolt 142 may extend a predefined distance x (FIG. 13) or retract the predefined distance x (FIG. 13) based on the length of the eye bolt 142 and the placement of the pin 166 on the eye bolt 142 within the gear-driven eye bolt assembly 134. The present disclosure is not limited to a particular size or shape of the guidance tip 170, the alignment body 172, the bumper, the eye bolt slot 176, the spherical bearing 178, or the fitting 180.

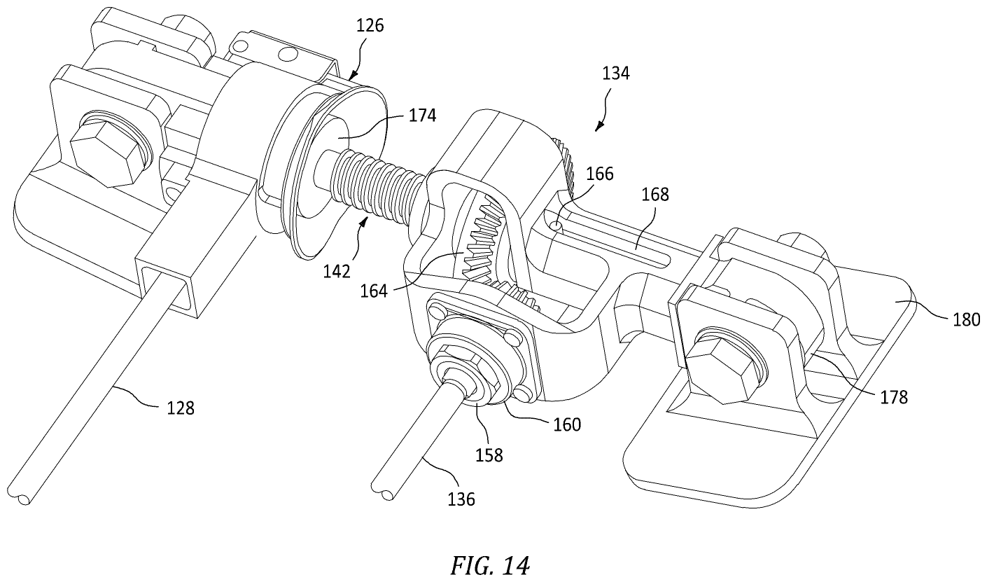

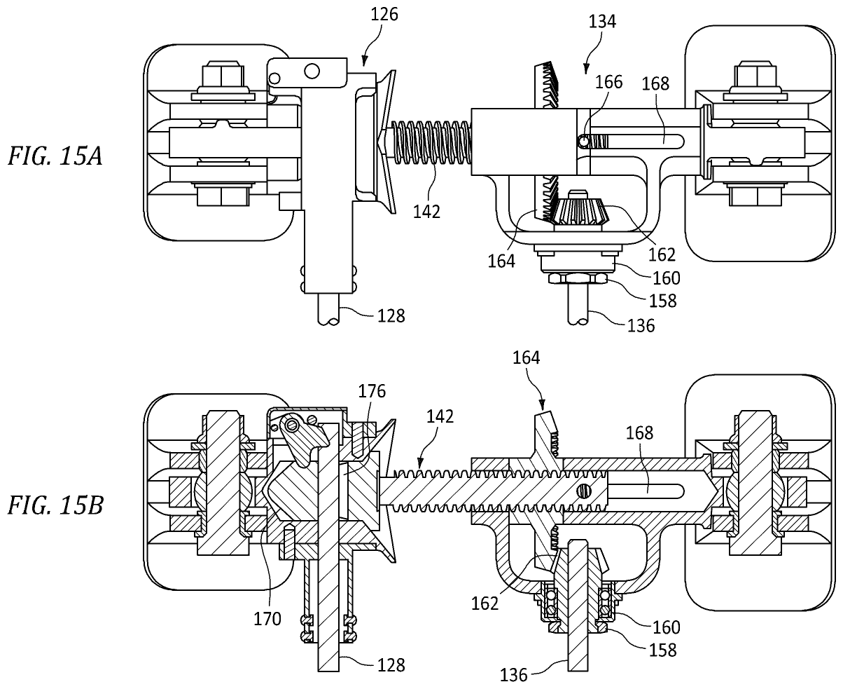

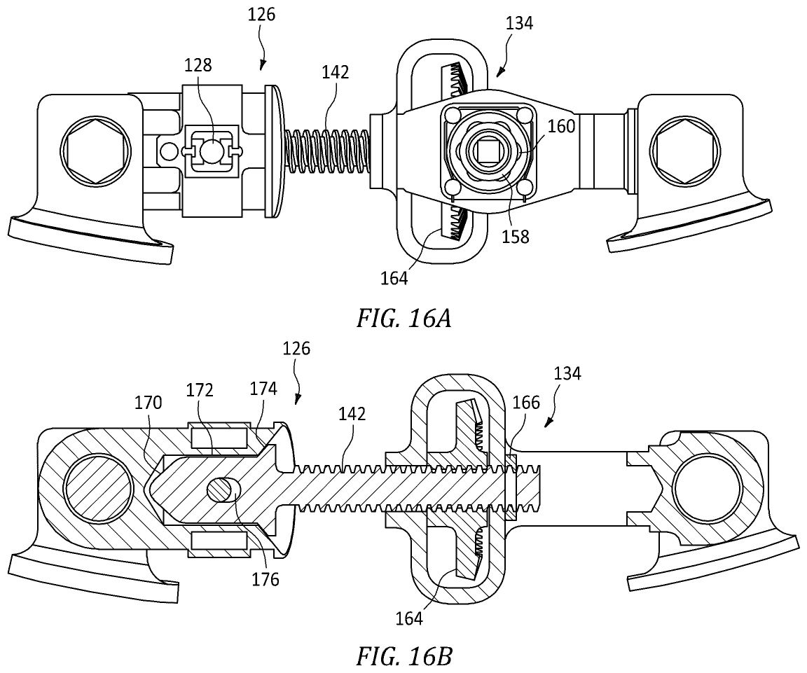

FIG. 14 schematically illustrates a perspective view of the gear-driven eye bolt assembly 134 engaged with the latch receiver 126 in the extended state. FIG. 15A schematically illustrates a radially outward view of the gear-driven eye bolt assembly 134 engaged with the latch receiver 126 in the extended state. FIG. 15B schematically illustrates a cutaway radially outward view of the gear-driven eye bolt assembly 134 engaged with the latch receiver 126 in the extended state. FIG. 16A schematically illustrates an axially forward view of the gear-driven eye bolt assembly 134 engaged with the latch receiver 126 in the extended state. FIG. 16B schematically illustrates a cutaway axially forward view of the gear-driven eye bolt assembly 134 engaged with the latch receiver 126 in the extended state.

As shown in FIGS. 14-16B, the eye bolt 142 is extended from within the gear-driven eye bolt assembly 134 and the guidance tip 170 and the alignment body 172 of the eye bolt 142 are disposed within the latch receiver 126 up to the bumper 174. The eye bolt 142 may be extended as far as permitted by the pin 166 within the slot 168 of the gear-driven eye bolt assembly 134. The drive rod 128 extends through the eye bolt slot 176 of the eye bolt 142 within the latch receiver 126. This state of the latch assembly allows an operator to pull thrust reverser halves closed when they are resting on seals and therefore not fully closed.

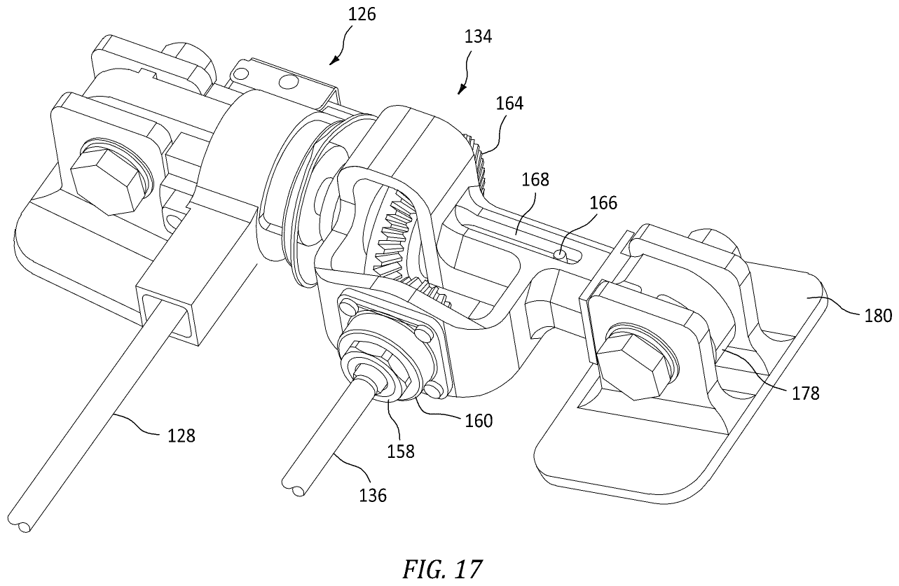

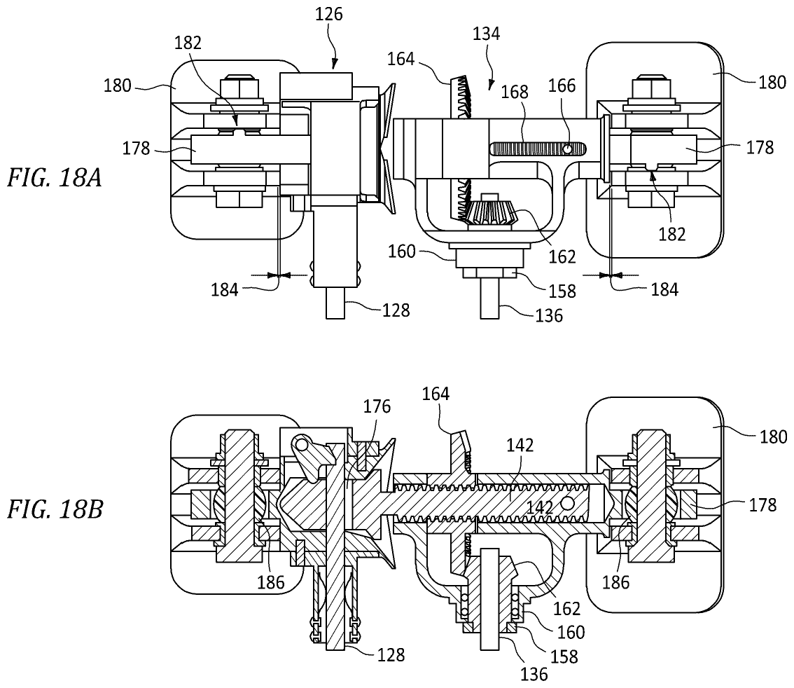

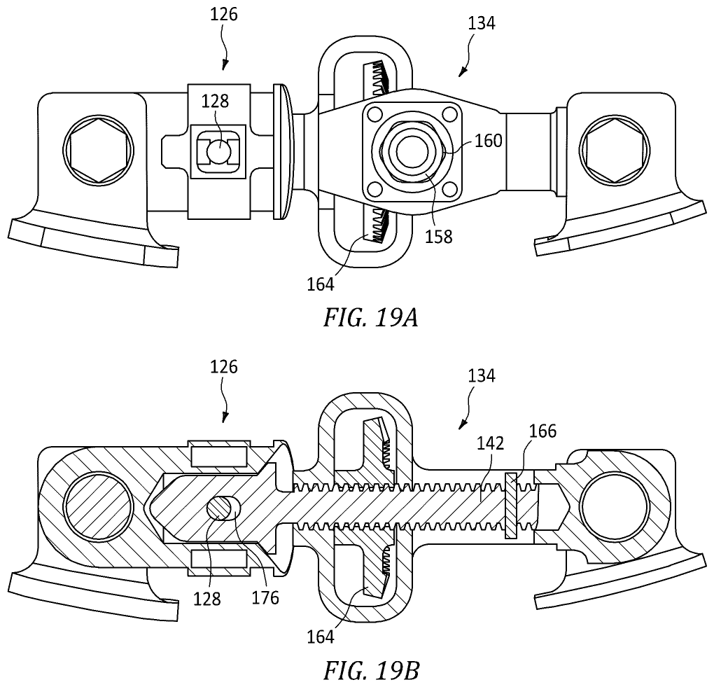

FIG. 17 schematically illustrates a perspective view of the gear-driven eye bolt assembly 134 engaged with the latch receiver 126 in the retracted state. FIG. 18A schematically illustrates a radially outward view of the gear-driven eye bolt assembly 134 engaged with the latch receiver 126 in the retracted state. FIG. 18B schematically illustrates a cutaway radially outward view of the gear-driven eye bolt assembly 134 engaged with the latch receiver 126 in the retracted state. FIG. 19A schematically illustrates an axially forward view of the gear-driven eye bolt assembly 134 engaged with the latch receiver 126 in the retracted state. FIG. 19B schematically illustrates a cutaway axially forward view of the gear-driven eye bolt assembly 134 engaged with the latch receiver 126 in the retracted state.

As shown in FIGS. 17-19B, the eye bolt 142 is retracted within the gear-driven eye bolt assembly 134 and the guidance tip 170 and the alignment body 172 of the eye bolt 142 are disposed within the latch receiver 126 up to the bumper 174. The eye bolt 142 may be retracted as far as permitted by the bumper 174 or the pin 166 within the slot 168 of the gear-driven eye bolt assembly 134. The drive rod 128 extends through the eye bolt slot 176 of the eye bolt 142 within the latch receiver 126. This state closes the thrust reverser halves. As shown in FIG. 18A, the latch receiver 126 may also engage with a fitting 180 via a spherical bearing 178. The spherical bearings 178 may be engaged with the fittings 180 with a 2x rotation limiter 182 therebetween. Additionally, a predetermined gap 184 may be disposed between the fitting 180 and the gear-driven eye bolt assembly 134 or the latch receiver 126. Further, as shown in FIG. 18B, an inner race of the spherical bearing 178 may be clamped to a lug 186 of the fitting 180.

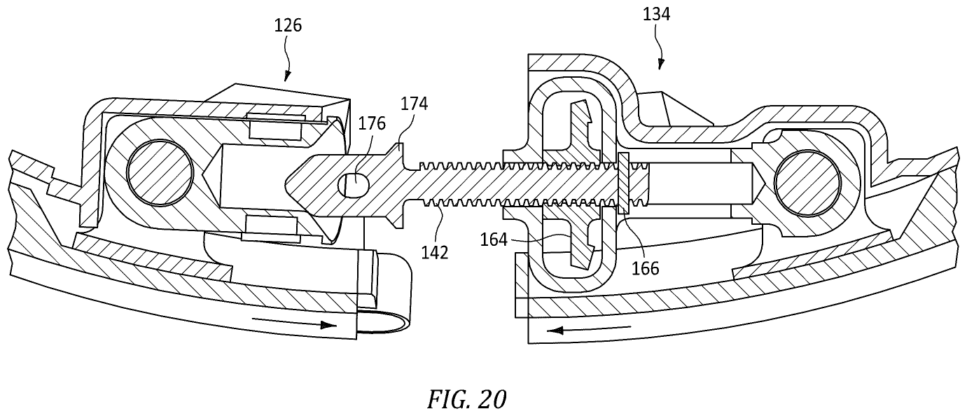

FIG. 20 schematically illustrates a cutaway axially forward view of the gear-driven eye bolt assembly 134 disengaged from the latch receiver 126 in the extended state, in accordance with one or more embodiments of the present disclosure. The eye bolt 142 is extended from within the gear-driven eye bolt assembly 134 by a distance of x and the guidance tip 170 and the alignment body 172 of the eye bolt 142 are at least partially withdrawn from the latch receiver 126. The eye bolt 142 may be extended as far as permitted by the pin 166 within the slot 168 of the gear-driven eye bolt assembly 134. The drive rod 128 does not extend through the eye bolt slot 176 of the eye bolt 142.

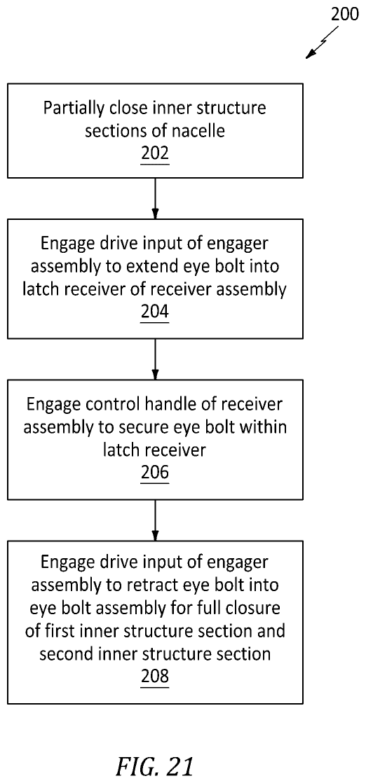

FIG. 21 is a flowchart illustrating a method 200 for operating a latch assembly of an aircraft. At 202, the first inner structure section 102A and the second inner structure section 102B of the nacelle 22 are partially closed together. The first inner structure section 102A may include the receiver assembly 125 of the latch assembly and the second inner structure section 102B may include the engager assembly 133 of the latch assembly, or vice versa.

At 204, the rotation lock 138 is released and the drive input 140 of the engager assembly 133 is engaged to extend the eye bolt 142 from the eye bolt assembly 134 of the engager assembly 133. The eye bolt 142 is extended into the latch receiver 126 of the receiver assembly 125. Engaging the drive input 140 may include rotating the drive input 140 and the first drive rod 136 in a first direction. The drive input 140 may be engaged with the eye bolt assembly 134 via the first drive rod 136. The first drive rod 136 may rotate the pinion gear 162 of the eye bolt assembly 134. The pinion gear 162 may be perpendicularly engaged with the ring gear 164 of the eye bolt assembly 134. Rotation of the ring gear 164 may translate the eye bolt 142 through the ring gear 164 and out from the eye bolt assembly 134.

At 206, the control handle 130 of the receiver assembly 125 is engaged to secure the eye bolt 142 within the latch receiver 126. Engaging the control handle 130 may include translating the second drive rod 128 through the eye bolt slot 176 of the eye bolt 142 within the latch receiver 126.

At 208, the rotation lock 138 is released and the drive input 140 is engaged to retract the eye bolt 142 into the eye bolt assembly 134 of the engager assembly 133 for full closure of the first inner structure section 102A and the second inner structure section 102B. Engaging the drive input 140 to retract the eye bolt may include rotating the drive input 140 in a second direction for rotation of the first drive rod 136, the pinion gear 162, and the ring gear 164, and for retraction of the eye bolt 142 through the ring gear 164 into the eye bolt assembly 134.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected, or the like may include permanent, removable, temporary, partial, full and/or any other possible attachment option.

The terms “substantially,” “about,” “approximately,” and other similar terms of approximation used throughout this patent application are intended to encompass variations or ranges that are reasonable and customary in the relevant field. These terms should be construed as allowing for variations that do not alter the basic essence or functionality of the invention. Such variations may include, but are not limited to, variations due to manufacturing tolerances, materials used, or inherent characteristics of the elements described in the claims, and should be understood as falling within the scope of the claims unless explicitly stated otherwise.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

1. A latch assembly for an aircraft, comprising:
an engager assembly comprising an eye bolt assembly, a first drive rod, and a drive input disposed remote from the eye bolt assembly, wherein:
the eye bolt assembly comprises an eye bolt; and
the drive input is operatively coupled to the eye bolt assembly via the first drive rod for translation of the eye bolt at the eye bolt assembly; and
a receiver assembly comprising a latch receiver and a control handle, wherein:
the latch receiver is configured to receive the eye bolt, and
the control handle is operatively coupled to the latch receiver for at least one of engagement or disengagement with the eye bolt within the latch receiver.

2. The latch assembly of claim 1, wherein the eye bolt assembly is gear driven, and rotation of the drive input and the first drive rod enables gear-driven translation of the eye bolt.

3. The latch assembly of claim 2, wherein the drive input is configured to accept a ratchet for rotation of the drive input and the first drive rod.

4. The latch assembly of claim 2, wherein:
the engager assembly further comprises a spring-loaded lock collar disposed proximate to the drive input, and a lock plate configured for engagement with the spring-loaded lock collar;
engagement of the spring-loaded lock collar and the lock plate disables rotation of the drive input with the first drive rod; and
disengagement of the spring-loaded lock collar and the lock plate enables rotation of the drive input with the first drive rod.

5. The latch assembly of claim 4, wherein the spring-loaded lock collar comprises lock collar teeth and the lock plate comprises lock plate teeth configured for engagement with the lock collar teeth.

6. The latch assembly of claim 2, wherein:
the eye bolt assembly comprises a pinion gear engaged with the first drive rod within the eye bolt assembly, and a ring gear perpendicularly engaged with the pinon gear within the eye bolt assembly;
the eye bolt is translationally engaged through a center of the ring gear; and
rotation of the first drive rod enables rotation of the pinion gear, rotation of the ring gear, and translation of the eye bolt.

7. The latch assembly of claim 2, wherein the eye bolt assembly comprises a pin disposed on the eye bolt within the eye bolt assembly, and a slot disposed on the eye bolt assembly and configured to receive the pin and restrict translation of the eye bolt based on a disposition of the pin within the slot.

8. The latch assembly of claim 1, wherein:
the receiver assembly further comprises a second drive rod;
the control handle is disposed remote from the latch receiver; and
the control handle is operatively coupled to the latch receiver via the second drive rod.

9. The latch assembly of claim 8, wherein the eye bolt comprises a guidance tip, an alignment body, and a bumper that enable proper alignment of the eye bolt within the latch receiver for engagement with the second drive rod.

10. The latch assembly of claim 9, wherein:
the eye bolt further comprises an eye bolt slot disposed through the alignment body;
the second drive rod extends through the eye bolt slot for engagement of the latch assembly; and
the second drive rod retracts from the eye bolt slot for disengagement of the latch assembly.

11. The latch assembly of claim 10, wherein the control handle is engaged with the second drive rod to enable translation of the second drive rod to extend through the eye bolt slot or retract from the eye bolt slot within the latch receiver.

12. The latch assembly of claim 8, wherein at least one of the first drive rod or the second drive rod comprises two angularly offset drive rod segments.

13. The latch assembly of claim 8, wherein:
the eye bolt assembly is engaged with a first fitting within a first inner structure section of a nacelle of the aircraft;
the latch receiver is engaged with a second fitting within a second inner structure section of the nacelle; and
the latch assembly is configured to latch the first inner structure section with the second inner structure section.

14. The latch assembly of claim 13, wherein:
the first drive rod and the drive input are disposed within the first inner structure section;
the second drive rod and the control handle are disposed within the second inner structure section;
the first inner structure section comprises a first latch access door on a first radially exterior surface that provides access to the drive input; and
the second inner structure section comprises a second latch access door on a second radially exterior surface that provides access to the control handle.

15. A latch assembly for an aircraft, comprising:
an engager assembly comprising an eye bolt assembly and a drive input, wherein:
the eye bolt assembly comprises an eye bolt; and
the drive input is operatively coupled to the eye bolt assembly for translation of the eye bolt at the eye bolt assembly; and
a receiver assembly comprising a latch receiver, a drive rod, and a control handle disposed remote from the latch receiver, wherein:
the latch receiver is configured to receive the eye bolt; and
the control handle is operatively coupled to the latch receiver via the drive rod for at least one of engagement or disengagement of the drive rod with the eye bolt within the latch receiver.

16. A method of operating a latch assembly of an aircraft, the method comprising:
partially closing a first inner structure section with a second inner structure section of a nacelle of the aircraft, wherein the first inner structure section comprises an engager assembly of the latch assembly, and the second inner structure section comprises a receiver assembly of the latch assembly;
engaging a drive input of the engager assembly to extend an eye bolt from an eye bolt assembly of the engager assembly, wherein the eye bolt is extended into a latch receiver of the receiver assembly;
engaging a control handle of the receiver assembly to secure the eye bolt within the latch receiver; and
engaging the drive input to retract the eye bolt into the eye bolt assembly for full closure of the first inner structure section with the second inner structure section.

17. The method of claim 16, wherein engaging the drive input to extend the eye bolt comprises releasing a rotation lock and rotating the drive input and a first drive rod in a first direction, wherein the drive input is engaged with the eye bolt assembly via the first drive rod.

18. The method of claim 17, wherein:
the first drive rod rotates a pinion gear of the eye bolt assembly;
the pinion gear is perpendicularly engaged with a ring gear of the eye bolt assembly; and
rotation of the ring gear translates the eye bolt through the ring gear and out from the eye bolt assembly.

19. The method of claim 18, wherein engaging the drive input to retract the eye bolt comprises releasing the rotation lock and rotating the drive input and the first drive rod in a second direction, enabling rotation of the pinion gear and the ring gear, and translation of the eye bolt through the ring gear into the eye bolt assembly.

20. The method of claim 16, wherein engaging the control handle comprises translating a second drive rod through an eye bolt slot of the eye bolt within the latch receiver.
